(19) United States
(12) Patent Application Publication
(10) Pub. No.: US 2025/0202779 A1
(43) Pub. Date: Jun. 19, 2025

(54) SYSTEM AND METHOD FOR GENERATING A DYNAMIC ALARM BASED ON TRAFFIC INFORMATION FROM SENSOR DATA

(71) Applicant: ELM, Riyadh (SA)

(72) Inventor: Hibah Mohammed ALDHAMDI, Riyadh (SA)

(73) Assignee: ELM, Riyadh (SA)

(21) Appl. No.: 18/982,696

(22) Filed: Dec. 16, 2024

Related U.S. Application Data
(60) Provisional application No. 63/610,197, filed on Dec. 14, 2023.

(51) Int. Cl. H04L 41/16; H04L 41/22

(52) U.S. Cl. CPC H04L 41/16; H04L 41/22

(57) ABSTRACT

A method includes receiving an input including a starting location, a destination, a time of arrival, a plurality of user-defined events, and a preparation time from a user; receiving traffic data from an integrated sensor system including a computing device including a processor, a memory, and a communication module, and an internet of things (IoT) sensor communicatively connected to the computing device, the IoT sensor configured to obtain traffic data; generating a first route option from the starting location to the destination based on the traffic data and the input from the user; determining, via an artificial intelligence model and based on the first route option, a total time to the destination; determining a dynamic alarm set time based on the total time to destination and the time of arrival; and instructing a first electronic device to set a dynamic alarm based on the alarm set time.

### CROSS-REFERENCE TO RELATED APPLICATIONS

The present application is related to U.S. Application No. 63/610,197, filed Dec. 14, 2023, the entire content of which is incorporated by reference herein in its entirety for all purposes.

### BACKGROUND

### Field of the Disclosure

The present disclosure relates to dynamically generating a notification or alarm for a user based on obtained traffic information using smart sensors and corresponding sensor data.

### Description of the Related Art

Traveling to a destination can often involve unexpected obstacles and delays, such as traffic, that alter an expected arrival time at the destination. While some technologies can provide approximated average traffic conditions for a given route, none can provide real-time traffic information.

The foregoing description is for the purpose of generally presenting the context of the disclosure. Work of the inventors, to the extent it is described in this background section, as well as aspects of the description which may not otherwise qualify as prior art at the time of filing, are neither expressly or impliedly admitted as prior art against the present disclosure.

### SUMMARY

The foregoing paragraphs have been provided by way of general introduction, and are not intended to limit the scope of the following claims. The described embodiments, together with further advantages, will be best understood by reference to the following detailed description taken in conjunction with the accompanying drawings.

In one embodiment, the present disclosure is related to a method, including receiving an input including a starting location, a destination, a time of arrival, a plurality of user-defined events, and a preparation time from a user; receiving traffic data from an integrated sensor system including a computing device including a processor, a memory, and a communication module, and an internet of things (IoT) sensor communicatively connected to the computing device, the IoT sensor configured to obtain traffic data; generating a first route option from the starting location to the destination based on the traffic data and the input from the user; determining, via an artificial intelligence model and based on the first route option, a total time to the destination; determining a dynamic alarm set time based on the total time to destination and the time of arrival; and instructing a first electronic device to set a dynamic alarm based on the alarm set time.

In one embodiment, the present disclosure is additionally related to a dynamic alarm system, comprising: an integrated sensor system, including a computing device including a processor, a memory, and a communication module, and an internet of things (IoT) sensor communicatively connected to the computing device, the IoT sensor configured to obtain traffic data; a first electronic device communicatively connected to the computing device and configured to generate an audio, visual, or physical alert; and a cloud system communicatively connected to the computing device via the communication module and the first electronic device, the cloud system configured to analyze the obtained traffic data based on an artificial intelligence model, wherein the cloud system includes processing circuitry configured to receive an input including a starting location, a destination, and a time of arrival from a user, receive the traffic data from the integrated sensor system, generate a first route option and corresponding first route data, determine, based on the first route option and corresponding first route data, a total time to the destination, determine a dynamic alarm set time based on the total time to destination and the time of arrival, and instruct the first electronic device to set a dynamic alarm based on the alarm set time.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a schematic view of a dynamic alarm system, according to an embodiment of the present disclosure;

FIG. 2A is a schematic of an example piezoelectric sensor installation in a roadway;

FIG. 2B is a schematic of an integrated piezoelectric sensor system, according to an embodiment of the present disclosure;

FIG. 3 is an exemplary flow chart for a method 300 of generating a dynamic alarm based on traffic data, user data, and external factor data, according to an embodiment of the present disclosure;

FIG. 4A shows an example of a general artificial neural network (ANN) having N inputs, K hidden layers, and three outputs;

FIG. 4B shows a non-limiting example in which the DL network is a convolutional neural network (CNN);

FIG. 5 is a schematic of a user device for performing a method, according to an exemplary embodiment of the present disclosure;

FIG. 6 is a schematic of a hardware system for performing a method, according to an exemplary embodiment of the present disclosure; and

FIG. 7 is a schematic of a hardware configuration of a device for performing a method, according to an exemplary embodiment of the present disclosure.

### DETAILED DESCRIPTION

The terms “a” or “an”, as used herein, are defined as one or more than one. The term “plurality”, as used herein, is defined as two or more than two. The term “another”, as used herein, is defined as at least a second or more. The terms “including” and/or “having”, as used herein, are defined as comprising (i.e., open language). Reference throughout this document to “one embodiment”, “certain embodiments”, “an embodiment”, “an implementation”, “an example” or similar terms means that a particular feature, structure, or characteristic described in connection with the embodiment is included in at least one embodiment of the present disclosure. Thus, the appearances of such phrases or in various places throughout this specification are not necessarily all referring to the same embodiment. Furthermore, the particular features, structures, or characteristics may be combined in any suitable manner in one or more embodiments without limitation.

The problem of delaying appointments and trying to arrive at the right time with unstable traffic conditions has become a worsening problem as more and more people are added to the driving pool. Additionally, the dynamic nature of traffic conditions can create an uncertain and inconsistent travel time that a user cannot correctly predict when preparing for scheduled events. This can not only include setting aside sufficient time for travel, but also for the user to complete a user's preparation routine, such as a morning preparation routine.

Although alarms are an integral part of modern life, not much progress has been made to improve alarm technology and to guarantee that a person will arrive in time to an appointment after setting an alarm. With the growth of the world population, unpredictability can be exacerbated based on various environmental factors, such as being located in a large city or a city with poor public transportation infrastructure to alleviate the roadway traffic. Further, traffic is unpredictable due to many factors beyond the number of vehicles on the road. One such factor is spontaneous traffic accidents, which can block two or more lanes on major roads at peak times, causing heavy traffic.

A static alarm set by a user can work on the basic concept of ringing or activating at a specific time set by the user, such as in advance of a scheduled event to provide the user a predetermined length of time to travel to the scheduled event as well as complete any preparation in advance of the traveling portion. This can be sufficient when an average user routine length is known and an average traffic delay is expected. However, due to the dynamic nature of traffic, a dynamic and adjusting alarm is often preferred.

While alarms are very useful for modern life, there is still room for improvement. One area of improvement is the ability of alarms to remotely monitor traffic conditions and automatically respond to any unexpected changes in traffic conditions. Thus, described herein is a system and method for a “smart” alarm or “dynamic” alarm that is capable of adjusting a time at which the dynamic alarm rings based on, for example, predicted traffic patterns, changes in traffic conditions determined from sensor data, current and predicted weather, and destination factors, among others.

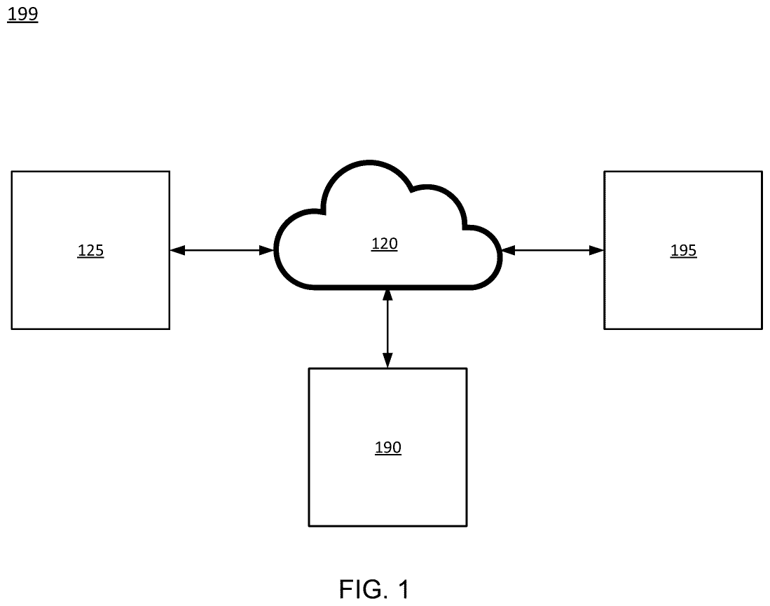

To this end, referring now to the Drawings, FIG. 1 is a schematic view of a dynamic alarm system 199, according to an embodiment of the present disclosure. In an embodiment, the system 199 can include a first electronic device 125, such as a user device, communicatively connected to a second electronic device 190, such as a server, via a network 120. A third electronic device 195, such as a sensor, sensor monitoring device, or integrated sensor system, can be communicatively connected to the first electronic device 125 and the second electronic device 190. The devices can be connected via a wired or a wireless connection. The connection between, for example, the first electronic device 125 and the second electronic device 190 can be via the network 120, wherein the network 120 is wireless. In an embodiment, the first electronic device 125 can be configured to obtain data from the user (of the first electronic device 125), such as user information (e.g., user (morning) routine data, user driving data, etc.). Notably, the first electronic device 125 can transmit the data over the communication network 120 to the networked second electronic device 190 and/or the third electronic device 195, and vice versa. Additionally or alternatively, more electronic devices can be included and networked in the dynamic alarm system 199.

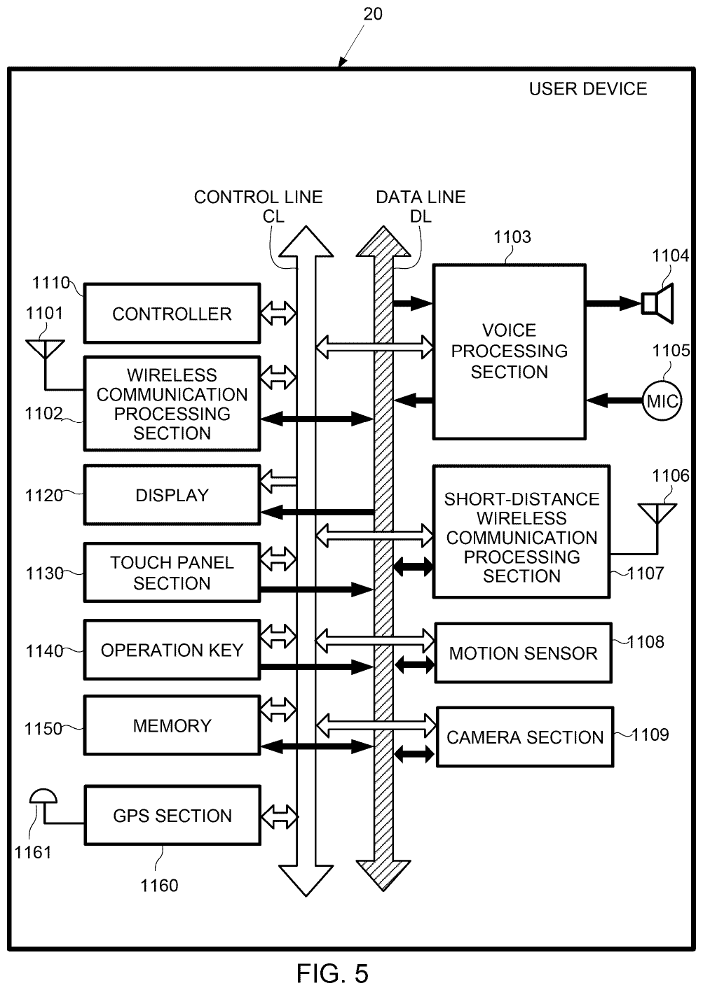

In an embodiment, the first electronic device 125 can include a central processing unit (CPU), among other components (discussed in more detail in FIGS. 5-7). The first electronic device 125 can be any electronic device such as, but not limited to, a smart-phone, a personal computer, a tablet pc, a smart-watch, a smart-television, an interactive screen, an IoT (Internet of things) device, or the like. An application can be installed or accessible on the first electronic device 125 for executing the methods described herein. The application can also be integrated into an operating system (OS) of the first electronic device 125. Notably, the first electronic device 105 can be used by a user to interact with the application, such as a dynamic alarm application, to input data and receive alerts and other output data.

In an embodiment, the system 100 can include one or more of the third electronic device 195. The third electronic device 195 can be, for example, an internet of things (IoT) device configured to transmit obtained or collected data. For example, the third electronic device 195 is a piezoelectric sensor configured to detect changes in mechanical force. In general, a piezoelectric sensor works by converting mechanical stress or forces into electrical signals using the piezoelectric effect. The piezoelectric effect is a property of certain materials, such as quartz, ceramics, or some polymers, that generate an electrical charge when subjected to mechanical force. The deformation caused in piezoelectric materials alters the distribution of electric dipoles in the material, creating an electrical charge on its surface. The amount of charge generated can be proportional to the applied force. The generated charge can be detected and converted into a measurable electrical signal, such as a high-impedance signal. Advantageously, piezoelectric sensors can be highly sensitive to rapid changes, making the piezoelectric sensors ideal for measuring dynamic events like frequent vibrations and deformation from vehicle wheels. Moreover, the high sensitivity can make the piezoelectric sensors more suited to detecting a weight of the vehicle and a speed of the vehicle traversing the piezoelectric sensor.

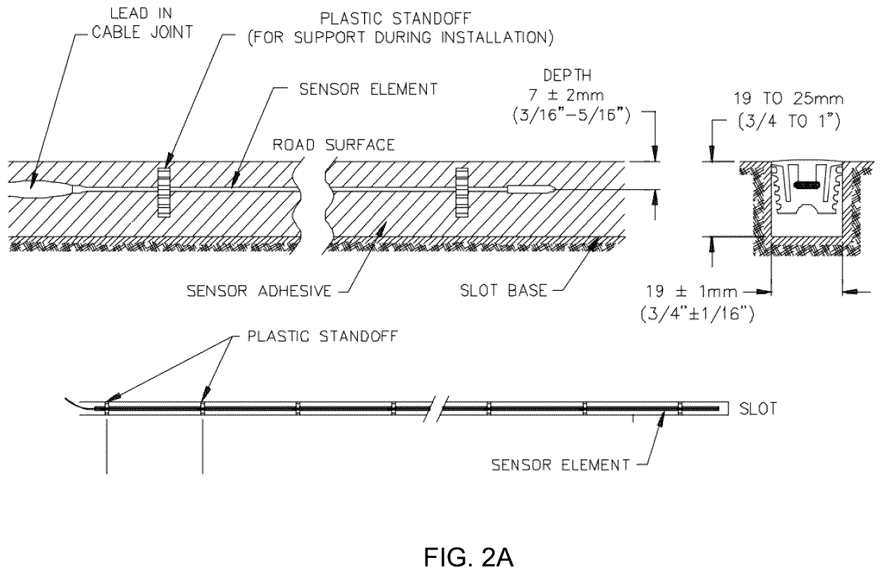

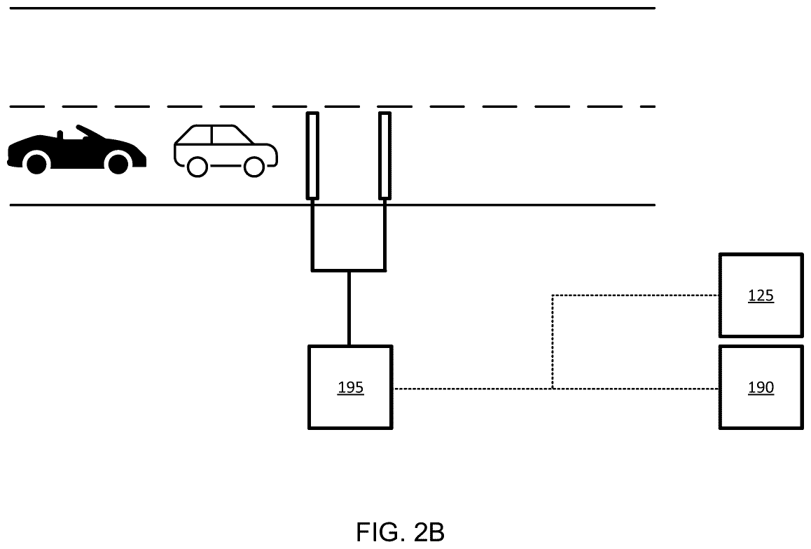

To this end, FIG. 2A is a schematic of an example piezoelectric sensor installation in a roadway. In an embodiment, the piezoelectric sensor (the third electronic device 195) can be installed on, in, or under a road. For example, the piezoelectric sensor can take the form of a long, narrow strip and be installed in a slot or groove cut into a surface of the road. A length of the slot or groove can run orthogonal to a direction or flow of the traffic, and therefore, when installed, the narrow strip piezoelectric sensor can be arranged such that a length of the piezoelectric sensor is also orthogonal to the direction of the traffic. For example, the piezoelectric sensor can include a plurality of sensor tracks, each sensor track of the plurality of sensor tracks taking the form of a loop of flat sensor wire having a height that is, for example, 0.05 to 0.5, or 0.075 to 0.4, or 0.1 to 0.3 times the width of the sensor track. The loop of flat sensor wire can be installed such that the width of the sensor track is orthogonal to an uppermost surface of the road. The sensor tracks can be disposed at a first distance no closer than 0.5 times a largest diameter of the loop. Each loop can be electrically connected to a feeder line that is orthogonal to a line of propagation of the sensor tracks in a direction of traffic traversing the road. Notably, the piezoelectric sensor can include electrodes or electrical contacts to detect the output electrical signal and transmit the signal to processing circuitry of a device.

FIG. 2B is a schematic of an integrated piezoelectric sensor system, according to an embodiment of the present disclosure. In an embodiment, the third electronic device 195 is the integrated sensor system including a computing device comprising processing circuitry, a memory, and a communication module, and at least one piezoelectric sensor. The piezoelectric sensor can be the narrow strip type of piezoelectric sensor and installed in, on, or under the road as previously described. The computing device can be arranged proximal to the piezoelectric sensor, electrically coupled to the piezoelectric sensor, and configured to receive an electrical signal from the piezoelectric sensor in response to an object applying a mechanical force to the piezoelectric sensor. The computing device can be configured to process the electrical signal and determine vehicle metrics based on the electrical signal, such as whether a vehicle has traversed over the piezoelectric sensor. Additionally or alternatively, the computing device can be configured to transmit, either over wired or wireless connectivity (via the communication module), the electrical signal and/or the vehicle metrics. For example, the computing device can transmit the vehicle metrics to the first electronic device 125 and/or the server (the second electronic device 190). The server can be, for example, a cloud system that includes a network of one or more servers accessible over the internet. The cloud system can be referred to as a server herein for simplicity. The server (cloud system) can store and access data, applications, and computing power on demand. For example, the computing device can transmit just the electrical signal to the server for the server to process the electrical signal and determine vehicle metrics. This can provide an advantage where the server can be remote and include higher processing power compared to the computing device, and therefore the server can be more efficient and take less time in processing the electrical signal data. It may be appreciated that the piezoelectric sensor itself can include a communication module configured to automatically transmit the collected electrical signal data to the server and/or the first electronic device 125.

As shown in FIG. 2B, in an embodiment, the third electronic device 195 as the integrated sensor system can include, for example, two of the piezoelectric sensors installed in, on, or under the road. The two piezoelectric sensors can work in combination to provide additional vehicle metrics or traffic metrics. The vehicle metrics a single piezoelectric sensor can provide include, for example, vehicle count, vehicle classification (e.g., personal two-axle vehicle or commercial 4-axle tractor trailer truck), and vehicle weight. When a second piezoelectric sensor is added, vehicle speed can also be discerned. That is, a vehicle can traverse the two piezoelectric sensors, and a front axle of the vehicle can cross the first piezoelectric sensor at time (t1) and the second piezoelectric sensor at time (t2), wherein the time difference (dt) between the two events can be used in combination with a distance separating the two piezoelectric sensors to determine a speed of the vehicle. For example, a small sedan can have a lower speed and therefore yields a larger value of (dt) for crossing the two piezoelectric sensors. For example, a sports car can have a higher speed and therefore yields a lower value of (dt) for crossing the two piezoelectric sensors. The vehicle metrics can be beneficial information in determining, for example, a current average vehicle speed or real-time traffic data along the corresponding road.

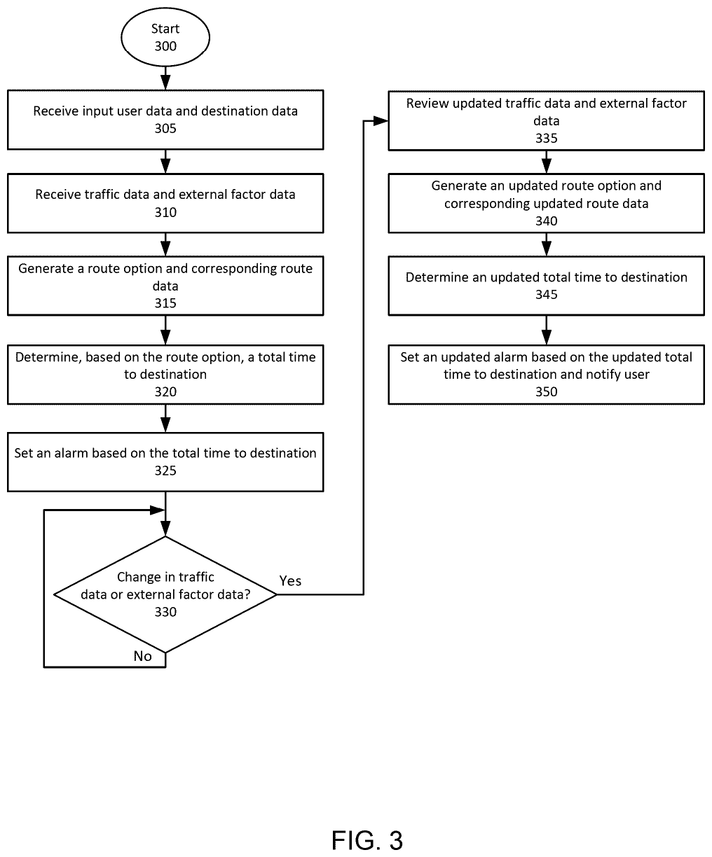

FIG. 3 is an exemplary flow chart for a method 300 of generating a dynamic alarm based on traffic data, user data, and external factor data, according to an embodiment of the present disclosure.

In an embodiment, step 305 is receiving user data and destination data input by the user.

In an embodiment, step 310 is receiving traffic data and external factor data.

In an embodiment, step 315 is generating a route option and corresponding route data based on the received traffic data and external factor data.

In an embodiment, step 320 is determining, based on the route option and corresponding route data, a total time to destination.

In an embodiment, step 325 is setting an alarm based on the total time to destination.

In an embodiment, step 330 is monitoring the traffic data and the external factor data and determining whether there is a change in the traffic data or the external factor data. Upon determining there is no change, the method 300 continues to monitor for changes in the traffic data or the external factor data. Upon determining there is a change, the method 300 proceed to step 335.

In an embodiment, step 335 is reviewing updated traffic data and external factor data.

In an embodiment, step 340 is generating an updated route option based on corresponding updated route data.

In an embodiment, step 345 is determining an updated total time to destination.

In an embodiment, step 350 is setting an updated alarm based on the updated total time to destination and notifying the user.

The steps of method 300 are further detailed herein. It can be appreciated that, for simplicity, any reference to an application, such as an application on a smart phone, performing an action can be interpreted as processing circuitry on the smart phone performing the action or the smart phone receiving instructions from the server. For example, a dynamic alarm application on the first electronic device 125 setting a dynamic alarm for the user can be interpreted as the server (the second electronic device 190) transmitting instructions to the first electronic device 125 to set the dynamic alarm.

With reference to step 305 in FIG. 3, in an embodiment, the user can be using an application on the first electronic device 125 for setting a dynamic alarm. The dynamic alarm can be an audio, visual, or physical alert, or a combination thereof. For example, the dynamic alarm is an audible alarm played at a high decibel level. For example, the dynamic alarm is a physical vibration. For example, the dynamic alarm is a steady or pulsing light emitted from the first electronic device 125, such as via a light source on the first electronic device 125 (e.g., the smart phone flash).

The application can allow for the user to create a user profile or similar, which can prompt the user for profile data related to the user. For example, the profile data can include a vehicle type, a morning preparation routine time, an evening preparation routine time, a work location, and a home location, among others. The vehicle type can affect, for example, a type of road the user can traverse with the user's vehicle. That is, in some locations, a motorcycle, hybrid electric, or fully electric vehicle can be permitted to use toll lanes or high occupancy vehicle (HOV) lanes that can bypass traffic occurring on proximal regular lanes, thereby reducing the total time to destination for the user. The morning preparation routine time can be an estimated time needed for the user to wake up, get ready, and leave the house. For example, the morning preparation routine time can be 30 minutes and include the time the user needs to bathe, dress, eat breakfast, and gather their belongings. The morning preparation routine time can further include, for example, a time to travel between the home and a common secondary location, such as a coffee shop or a childcare provider. In such an example, travel to the secondary location can be included as part of the morning preparation routine, and the generated route option (described below) can be generated from the secondary location instead of the home location. The home location information can be an address at which the user resides and used in determining the total time to destination.

In an embodiment, the user data can include the profile data input by the user as well as additional passive data corresponding to the user. The passive data can include data collected by the user's smart phone or connected smart devices in the user's home. For example, the user's smart phone can include sensors, such as a camera a GPS, and a gyroscope, that can detect various user actions and movement. For example, the gyroscope and camera can detect when the user wakes up, all three sensors can detect where the user takes the user's phone throughout the morning preparation routine, and finally all three sensors can detect when the user steps out of the door and begins the travel to the destination. Similarly, the connected smart devices in the user's home can include sensors, such as cameras, microphones, and infrared (IR) sensors, for detecting when the user is in a particular room. The passive data obtained by the various devices and sensors can determine, for example, even though the user input a morning preparation routine time of 30 minutes, the user actually needs an average of 45 minutes to complete the user's morning preparation routine. This can be accounted for when determining the total time to destination and setting the alarm (described below).

In an embodiment, once collected and as the user data is updated, the input user data and can be transmitted to the server (the second electronic device 190). That is, in an embodiment, the server can receive the transmitted input user data. Additionally, the user can input destination data, such as an address and a time of arrival. The destination data can be transmitted to the server. That is, the server can receive the transmitted destination data.

While users can use an application to search for a destination and learn an estimated travel time to the destination, these applications are not able to incorporate current, real-time traffic data to provide a highly accurate travel time to the destination. Furthermore, these applications lack any integration with other applications that can intelligently set alarms or alerts to improve the travel preparation for the user while also monitoring real-time sensor data to adjust or update the set alarms. To this end, in an embodiment, the user can use a dynamic alarm application on, for example, the user's smart phone to ensure that an alarm is set not only for a manually entered destination, but also for any scheduled events input by the user in a scheduling application also on the user's smart phone. That is, the dynamic alarm application can integrate with any scheduling application to obtain or receive scheduled event data from the scheduling application and, for each scheduled event, determine whether a dynamic alarm should be set and set a dynamic alarm when necessary for the user. For example, the user can input a job interview event into the user's Outlook calendar that includes a time and a destination for the job interview. The dynamic alarm application as presented herein can automatically receive or pull the job interview event from the Outlook calendar and transmit the time and destination data for the job interview event to the server. The server can determine whether a dynamic alarm should be set for the job interview event. Since the job interview event can be determined a high priority scheduled event, the server can use the method described herein to determine the total time to destination and set the dynamic alarm automatically for the user to prevent the user being late to, or missing entirely, the scheduled event. Notably, artificial intelligence (AI) models can be leveraged to analyze all of the data and generate a more accurate total time to destination. Further, the models can be trained and refined using training datasets as well as actual historical travel data from each specific user to tailor the AI models to the specific user.

With reference to step 310 in FIG. 3, in an embodiment, the traffic data obtained from the piezoelectric sensor(s) can be transmitted by the piezoelectric sensors or the computing device to the server. When the piezoelectric sensors transmit the electrical signals directly, or when the computing device does not process the electrical signals and transmits the electrical signals directly, the server can receive the transmitted electrical signals and perform the processing of the electrical signals to generate the traffic data. Again, the computing power at the server can be much greater than the computing device, and therefore the server can process the electrical signals more efficiently and quickly. In such a scenario, the electrical signals can be considered the traffic data. When the computing device processing the electrical signals, the computing device can generate, based on the electrical signals, the traffic data. As previously mentioned, the traffic data can include the vehicle count, the vehicle classifications, the vehicle weights, and the vehicle speeds. The traffic data can be further processed to determine, for example, a traffic score or weight that describes the roadway congestion intensity. Importantly, the traffic data can be used to determine a travel time needed for the user to traverse the roadway based on the current traffic data.

Further factors can affect the travel time needed for the user to traverse the roadway and arrive at the destination, which together can be termed external factor data. For example, the external factor can be weather conditions, holiday travel patterns, weekday versus weekend travel patterns, a local event schedule, and a destination parking availability, among others. While destination parking availability may not affect the time needed to traverse the roadway, it can affect a “door-to-door” time since a user may arrive at a destination with poor parking availability and need to spend additional time locating a free parking spot before being able to attend the scheduled event. Taken separately or in combination, the aforementioned can contribute to the total time to destination. Advantageously, artificial intelligence can be leveraged to determine and weigh each external factor in the external factor data to more accurately determine the total time to destination.

With reference to step 315 in FIG. 3, in an embodiment, the server can generate a route option and corresponding route data based on the received user data, the received destination data, the received traffic data, and the received external factor data. The route option can minimize a travel time between the user's starting location and the destination while factoring in the aforementioned datasets.

For example, the traffic data can be used to determine real-time delay times for each possible route option when the user is requesting an on-the-fly recommendation. For example, the received external factor data can be used to determine that a first route option and a second route option have a similar travel time, but that the second route option passes near a sports arena on the day of a scheduled sports event, which can exacerbate the traffic leading up to a start of the scheduled sports event. This example can be both for an on-the-fly recommendation, as well as when the dynamic alarm application is retrieving scheduled event data from the user's scheduling application and pre-planning for the user. That is, the dynamic alarm application can retrieve the job interview event data that is scheduled in the future and transmit it to the server, and the server can determine that, on the same day and at around the same time, the sports event is also scheduled. Therefore, based on the external factor data, the server can determine the first route option provides the quickest travel time while also minimizing any potential spontaneous traffic intensifying events.

The external factor data can be analyzed by, for example, the previously mentioned AI model to analyze the scheduled event data, analyze the local event schedule, detect the scheduled sports event occurring near one of the route options, and determining an alternative route option provides a better user travel experience. Of course, all of the route options or a curated list of the most recommended route options can be presented along with the relevant route data to the user for selection. While the server can generate the route options, it can be appreciated that other programs can be used via available API integration to generate the route options, such as Google Maps, Apple Maps, and the like.

In another example the first route option and the second route option provide similar travel times again. Further, poor weather conditions can be developing. In such a scenario, the AI model can be used to analyze previous traffic data for the first route option and the second route option and determine that the first route option often experiences a greater traffic intensity compared to the second route option (in addition to any expected baseline traffic). Therefore, the second route option can be recommended to the user. Even further, the AI model can be used to analyze topographical data along both route options and determine that the first route option includes a portion with low elevation and therefore is at a high risk of flooding. Therefore, the second route option can be recommended again to the user while providing a warning that there is a flood zone risk along the first route option.

With reference to step 320 in FIG. 3, in an embodiment, the server can determine a total time to destination for the route option or all route options. The server can transmit the total time to destination and the corresponding route option to the first electronic device 125. When the user is requesting an on-the-fly recommendation, the dynamic alarm application can provide all of the route options and all of the corresponding total times to destination for the user to review and select.

Advantageously, the total time to destination can also be based on the user data and the destination data. When the travel experience is being pre-planned for the user, such as traveling to work every morning, the server can factor in, for example, the user's morning preparation routine time. That is, the server can determine the best or fastest route option has a travel time of 20 minutes, but the user's morning preparation routine time adds another 30 minutes from when the user wakes up. Thus, the total time to destination can be 50 minutes, and the dynamic alarm can be set accordingly.

To this end, with reference to step 325 in FIG. 3, in an embodiment, a dynamic alarm set time can be determined based on the total time to destination, and the dynamic alarm can be set by the first electronic device 125. That is, the server can transmit instructions to the first electronic device 125 to set the corresponding dynamic alarm for the user at the dynamic alarm set time. Further, the passive data collected regarding the user's actual (versus input) morning preparation routine time can be accommodated in the total time to destination and correspondingly set alarm. For example, the dynamic alarm set for the user to go to work can be set for 50 minutes before the start of the work event when the user's input morning preparation routine time is used. When the user's morning preparation routine time is adjusted to the time described by the passive data collected, the dynamic alarm set for the user to go to work can be set for 65 minutes before the start of the work event instead. As the user's morning preparation routine time varies over time, the AI model can be used to continually refine the passive data and adjust the setting of the dynamic alarm. Of course, the dynamic alarm set time can always err on the side of caution and provide the user with extra time to reach the destination versus not providing the user sufficient time.

With reference to step 330 in FIG. 3, in an embodiment, the server can continually monitor the received traffic data and the received external factor data for changes, which can be continually transmitted to the server. The advantages of the described system and method that leverage the real-time piezoelectric sensor data are highlighted herein.

Upon determining there is no change in the received traffic data and the received external factor data, the method 300 can continue monitoring for changes at step 330.

Upon determining or detecting there is a change in the received traffic data and the received external factor data, which can be considered updated traffic data and updated external factor data, the method 300 can proceed to step 335.

With reference to step 335 in FIG. 3, in an embodiment, the updated traffic data and the updated external factor data can be reviewed to determine the changes and the impact of the changes on the total time to destination. For example, the server can determine, based on the updated traffic data, that the previously set dynamic alarm is not sufficiently early in order for the user to arrive at the destination on time. The updated traffic data for the roadway corresponding to the route option can describe, for example, that the real-time vehicle count for a given time window has increased and the real-time vehicle speed has decreased, thereby indicating intensifying traffic conditions. This can be provided by, as previously described, the piezoelectric sensors and the computing device. The intensifying traffic conditions can cause a concomitant increase in the expected delay time along the route option. Therefore, the dynamic alarm set in step 325 can need an adjustment to account for the increased delay time (updated travel time) as well as a review of all the route options to determine whether the original route option provides the quickest travel time.

To this end, and with reference to step 340 in FIG. 3, in an embodiment, the server can generate an updated route option and corresponding updated route data based on the received user data, the received destination data, the updated traffic data, and the updated external factor data. The updated route option can still minimize a travel time between the user's starting location and the destination while factoring in the aforementioned datasets. Of course, the originally determined route option can still be the best route option, and the server need not determine a different route option than the originally determined route option is the best updated route option. Similarly, the corresponding updated route data can be transmitted to the first electronic device 125 along with the updated route option.

With reference to step 345 in FIG. 3, in an embodiment, the server can determine an updated total time to destination based on the updated route option. The example of the user's morning preparation routine to go to work can be referenced again. The updated total time to destination can still accommodate the morning preparation routine time in addition to the updated travel time with the increased delay time when the updated total time to destination is determined with sufficient time remaining to adjust the dynamic alarm before the user must wake up and get ready for work. In this scenario, the updated dynamic alarm can be set for an earlier time. A scenario when there is insufficient time remaining to adjust the dynamic alarm is described below.

With reference to step 350 in FIG. 3, in an embodiment, the server can transmit instructions to the first electronic device 125 to set the updated dynamic alarm based on the updated total time to destination. Further, the server can transmit instructions to the first electronic device 125 to notify or alert the user of the update. When the updated dynamic alarm is set before a predetermined time, such as before the user's bed time, the dynamic alarm application can push a notification with an audible and visible alert to alert the user that the updated dynamic alarm has been set to an earlier time. When the updated dynamic alarm is set after the predetermined time, the dynamic alarm application can push a silent notification instead, such as just the visible alert. Additionally or alternatively, the dynamic alarm application can display a message with the sounding of the updated dynamic alarm to notify the user of the earlier set time. For example, the message can read “Please note your dynamic alarm was adjusted 15 minutes earlier for 7:15 AM due to increasing traffic developing along your route.” Additionally or alternatively, the dynamic alarm application can also push the notification with the audible alert even though the user is asleep to motivate the user to check the notification and be aware the updated dynamic alarm will wake them up earlier than anticipated.

The server can also determine there is insufficient time remaining to adjust the dynamic alarm. For example, the receiving the updated traffic data and the updated external factor data and determining the updated total time to destination can occur while the user is following the user's typical morning preparation routine. Therefore, the user can still be under the impression that the total time to destination has not changed. In such a scenario, the server can transmit instructions to the first electronic device 125 to notify the user using an alert that is audible, visible, and physical. The dynamic alarm application can, for example, trigger the same sound used for the dynamic alarm along with a vibration pulse and flashing lights. Additionally or alternatively, the dynamic alarm application can, for example, cause the connected devices in the user's vicinity to also output an alert to further ensure the user's attention is obtained. That is, the server can transmit instructions to the connected devices in the user's vicinity to also output the alert.

When the user checks the notification and/or silences the updated dynamic alarm, the updated total time to destination, the updated route option, and the corresponding updated route data can be displayed to the user. Additionally or alternatively, the dynamic alarm application can, for example, determine the progress of the user in the user's morning preparation routine and generate a recommendation to the user to skip a portion of the morning preparation routine in order to leave the user's home with enough trip time remaining. For example, the dynamic alarm application can display a message reading: “Traffic is increasing along your route and you need to leave 15 minutes earlier to arrive on time. To save time, you could skip making breakfast. Would you like a breakfast sandwich to be ordered and delivered to your destination instead via DoorDash or Uber Eats?”

The system and method described herein supports emerging technologies from data analysis and collection in a unique and reliable way using the piezoelectric sensors. The system and method (and the dynamic alarm application) can help users adjust, in real-time, their preparation routines and selected travel routes to ensure a timely arrival at their destination.

In addition, the optimized route selection can help reduce further traffic build-up by facilitating even distribution of commuters along various routes. This can increase overall productivity, but importantly, dramatically increases the user's productivity. This can also reduce transportation expenses, such as fuel consumption, which can also reduce pollution. Of course, a more accurate total time to destination is provided which can reduce stress and downstream delays. The continual monitoring of the traffic data and the external factor data can provide peace of mind for the user that the most current optimized route is always selected without the user needing to re-request or refresh anything.

As previously mentioned, the system and method can use trained AI models to analyze the various datasets and generate or determine the relevant outputs. The AI can be a collection of technologies that excel at extracting insights and patterns from large sets of data. The accuracy of the generated outputs, such as the calculated total time to destination, can be further improved by refining or further training the AI models using improved training data, such as training data including historical trip data for the specific user or users matching a similar profile to the specific user. Example AI models, such as neural networks, are described below.

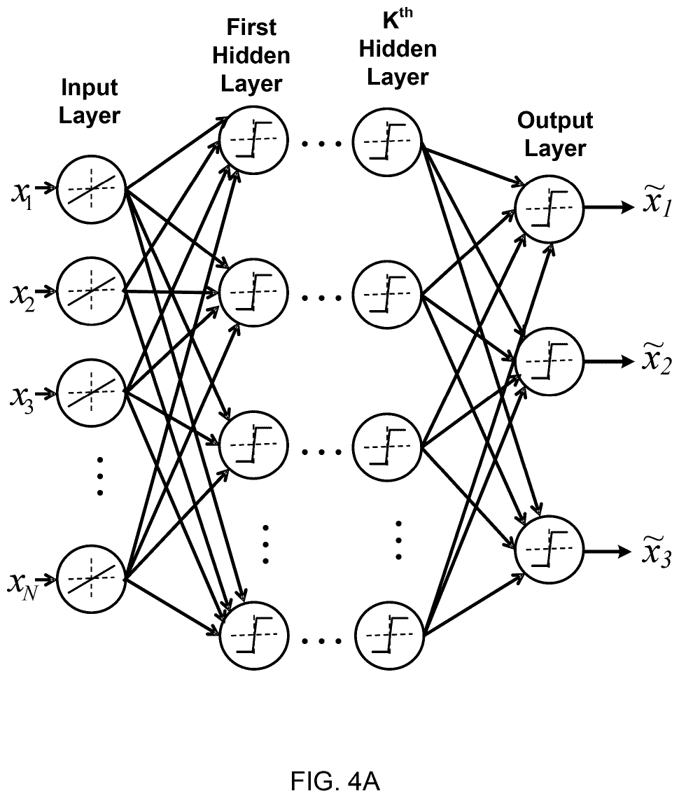

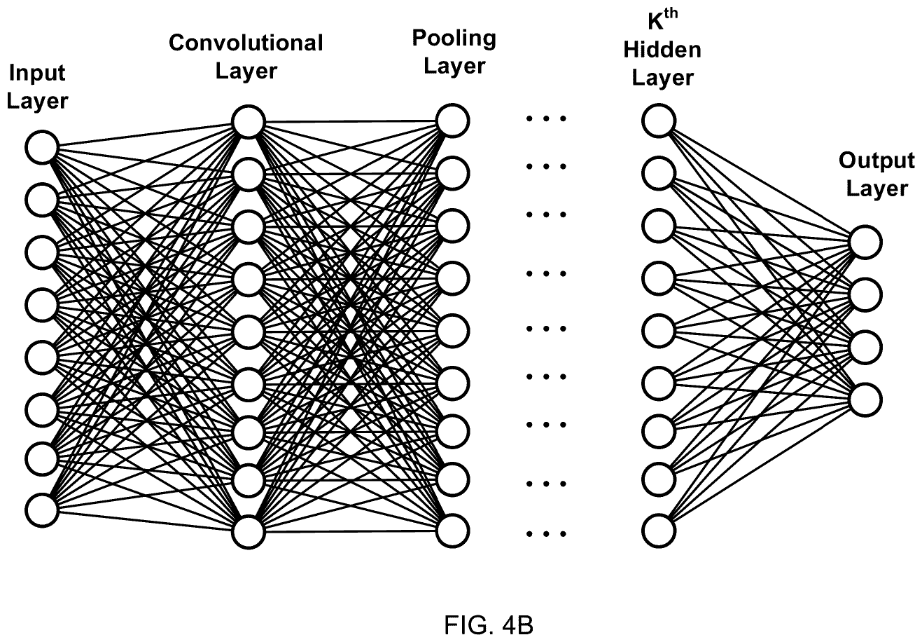

FIGS. 4A and 4B show various examples of a deep learning (DL) network.

FIG. 4A shows an example of a general artificial neural network (ANN) having N inputs, K hidden layers, and three outputs. Each layer is made up of nodes (also called neurons), and each node performs a weighted sum of the inputs and compares the result of the weighted sum to a threshold to generate an output. ANNs make up a class of functions for which the members of the class are obtained by varying thresholds, connection weights, or specifics of the architecture such as the number of nodes and/or their connectivity. The nodes in an ANN can be referred to as neurons (or as neuronal nodes), and the neurons can have inter-connections between the different layers of the ANN system. The simplest ANN has three layers, and is called an autoencoder. The DL network generally has more than three layers of neurons, and has as many outputs neurons IN as input neurons, wherein N is the number of pixels in the reconstructed image (sinogram). The synapses (i.e., the connections between neurons) store values called “weights” (also interchangeably referred to as “coefficients” or “weighting coefficients”) that manipulate the data in the calculations. The outputs of the ANN depend on three types of parameters: (i) the interconnection pattern between the different layers of neurons, (ii) the learning process for updating the weights of the interconnections, and (iii) the activation function that converts a neuron's weighted input to its output activation.

Mathematically, a neuron's network function m(x) is defined as a composition of other functions nᵢ(x), which can further be defined as a composition of other functions. This can be conveniently represented as a network structure, with arrows depicting the dependencies between variables, as shown in the figures. For example, the ANN can use a nonlinear weighted sum, wherein m(x)=K(Σᵢwᵢnᵢ(x)), where K (commonly referred to as the activation function) is some predefined function, such as the hyperbolic tangent.

In FIG. 4A (and similarly in FIG. 4B), the neurons (i.e., nodes) are depicted by circles around a threshold function. For the non-limiting example shown in FIG. 4A, the inputs are depicted as circles around a linear function, and the arrows indicate directed connections between neurons. In certain implementations, the DL network is a feedforward network as exemplified in FIGS. 4A and 4B (e.g., it can be represented as a directed acyclic graph).

The DL network operates to achieve a specific task, such as determining an optimized route option, by searching within the class of functions F to learn, using a set of observations, to find m *∈F which solves the specific task in some optimal sense. For example, in certain implementations, this can be achieved by defining a cost function C: F→m such that, for the optimal solution m *, C(m *)≤C(m)∇m∈F (i.e., no solution has a cost less than the cost of the optimal solution). The cost function C is a measure of how far away a particular solution is from an optimal solution to the problem to be solved (e.g., the error). Learning algorithms iteratively search through the solution space to find a function that has the smallest possible cost. In certain implementations, the cost is minimized over a sample of the data (i.e., the training data).

FIG. 4B shows a non-limiting example in which the DL network is a convolutional neural network (CNN). CNNs are type of ANN that has beneficial properties for image processing, and, therefore, have specially relevancy for the applications of image denoising and sinogram restoration. CNNs use feed-forward ANNs in which the connectivity pattern between neurons can represent convolutions in image processing. For example, CNNs can be used for image-processing optimization by using multiple layers of small neuron collections which process portions of the input image, called receptive fields. The outputs of these collections can then tiled so that they overlap, to obtain a better representation of the original image. This processing pattern can be repeated over multiple layers having alternating convolution and pooling layers.

Embodiments of the subject matter and the functional operations described in this specification can be implemented by digital electronic circuitry (on one or more of devices 125, 190, 195, etc.), in tangibly embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory program carrier for execution by, or to control the operation of data processing apparatus, such as the devices of FIG. 1 (e.g., devices 125, 190, 195, etc.) or the like. The computer storage medium can be a machine-readable storage device, a machine-readable storage substrate, a random or serial access memory device, or a combination of one or more of them.

The term “data processing apparatus” refers to data processing hardware and may encompass all kinds of apparatus, devices, and machines for processing data, including by way of example a programmable processor, a computer, or multiple processors or computers. The apparatus can also be or further include special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, Subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA an ASIC.

Computers suitable for the execution of a computer program include, by way of example, general or special purpose microprocessors or both, or any other kind of central processing unit. Generally, a CPU will receive instructions and data from a read-only memory or a random access memory or both. Elements of a computer are a CPU for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few. Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more Such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients (user devices) and servers. A client and server are generally remote from each other and typically interact through a communication network. The relationship of client and server arises by virtue of computer programs running on the respective computers and having a client-server relationship to each other. In an embodiment, a server transmits data, e.g., an HTML page, to a user device, e.g., for purposes of displaying data to and receiving user input from a user interacting with the user device, which acts as a client. Data generated at the user device, e.g., a result of the user interaction, can be received from the user device at the server.

Electronic user device 20 shown in FIG. 5 can be an example of one or more of the devices shown in FIG. 1. In an embodiment, the electronic user device 20 may be a smartphone. However, the skilled artisan will appreciate that the features described herein may be adapted to be implemented on other devices (e.g., a laptop, a tablet, a server, an e-reader, a camera, a navigation device, etc.). The exemplary user device 20 of FIG. 5 includes processing circuitry, as discussed above. The processing circuitry includes one or more of the elements discussed next with reference to FIG. 5. The electronic user device 20 may include other components not explicitly illustrated in FIG. 5 such as a CPU, GPU, frame buffer, etc. The electronic user device 20 includes a controller 1110 and a wireless communication processor 1102 connected to an antenna 1101. A speaker 1104 and a microphone 1105 are connected to a voice processor 1103.

The controller 1110 may include one or more processors/processing circuitry (CPU, GPU, or other circuitry) and may control each element in the user device 20 to perform functions related to communication control, audio signal processing, graphics processing, control for the audio signal processing, still and moving image processing and control, and other kinds of signal processing. The controller 1110 may perform these functions by executing instructions stored in a memory 1150. Alternatively or in addition to the local storage of the memory 1150, the functions may be executed using instructions stored on an external device accessed on a network or on a non-transitory computer readable medium.

The memory 1150 includes but is not limited to Read Only Memory (ROM), Random Access Memory (RAM), or a memory array including a combination of volatile and non-volatile memory units. The memory 1150 may be utilized as working memory by the controller 1110 while executing the processes and algorithms of the present disclosure. Additionally, the memory 1150 may be used for long-term storage, e.g., of image data and information related thereto.

The user device 20 includes a control line CL and data line DL as internal communication bus lines. Control data to/from the controller 1110 may be transmitted through the control line CL. The data line DL may be used for transmission of voice data, displayed data, etc.

The antenna 1101 transmits/receives electromagnetic wave signals between base stations for performing radio-based communication, such as the various forms of cellular telephone communication. The wireless communication processor 1102 controls the communication performed between the user device 20 and other external devices via the antenna 1101. For example, the wireless communication processor 1102 may control communication between base stations for cellular phone communication.

The speaker 1104 emits an audio signal corresponding to audio data supplied from the voice processor 1103. The microphone 1105 detects surrounding audio and converts the detected audio into an audio signal. The audio signal may then be output to the voice processor 1103 for further processing. The voice processor 1103 demodulates and/or decodes the audio data read from the memory 1150 or audio data received by the wireless communication processor 1102 and/or a short-distance wireless communication processor 1107. Additionally, the voice processor 1103 may decode audio signals obtained by the microphone 1105.

The exemplary user device 20 may also include a display 1120, a touch panel 1130, an operation key 1140, and a short-distance communication processor 1107 connected to an antenna 1106. The display 1120 may be a Liquid Crystal Display (LCD), an organic electroluminescence display panel, or another display screen technology. In addition to displaying still and moving image data, the display 1120 may display operational inputs, such as numbers or icons which may be used for control of the user device 20. The display 1120 may additionally display a GUI for a user to control aspects of the user device 20 and/or other devices. Further, the display 1120 may display characters and images received by the user device 20 and/or stored in the memory 1150 or accessed from an external device on a network. For example, the user device 20 may access a network such as the Internet and display text and/or images transmitted from a Web server.

The touch panel 1130 may include a physical touch panel display screen and a touch panel driver. The touch panel 1130 may include one or more touch sensors for detecting an input operation on an operation surface of the touch panel display screen. The touch panel 1130 also detects a touch shape and a touch area. Used herein, the phrase “touch operation” refers to an input operation performed by touching an operation surface of the touch panel display with an instruction object, such as a finger, thumb, or stylus-type instrument. In the case where a stylus or the like is used in a touch operation, the stylus may include a conductive material at least at the tip of the stylus such that the sensors included in the touch panel 1130 may detect when the stylus approaches/contacts the operation surface of the touch panel display (similar to the case in which a finger is used for the touch operation).

In certain aspects of the present disclosure, the touch panel 1130 may be disposed adjacent to the display 1120 (e.g., laminated) or may be formed integrally with the display 1120. For simplicity, the present disclosure assumes the touch panel 1130 is formed integrally with the display 1120 and therefore, examples discussed herein may describe touch operations being performed on the surface of the display 1120 rather than the touch panel 1130. However, the skilled artisan will appreciate that this is not limiting.

For simplicity, the present disclosure assumes the touch panel 1130 is a capacitance-type touch panel technology. However, it should be appreciated that aspects of the present disclosure may easily be applied to other touch panel types (e.g., resistance-type touch panels) with alternate structures. In certain aspects of the present disclosure, the touch panel 1130 may include transparent electrode touch sensors arranged in the X-Y direction on the surface of transparent sensor glass.

The touch panel driver may be included in the touch panel 1130 for control processing related to the touch panel 1130, such as scanning control. For example, the touch panel driver may scan each sensor in an electrostatic capacitance transparent electrode pattern in the X-direction and Y-direction and detect the electrostatic capacitance value of each sensor to determine when a touch operation is performed. The touch panel driver may output a coordinate and corresponding electrostatic capacitance value for each sensor. The touch panel driver may also output a sensor identifier that may be mapped to a coordinate on the touch panel display screen. Additionally, the touch panel driver and touch panel sensors may detect when an instruction object, such as a finger is within a predetermined distance from an operation surface of the touch panel display screen. That is, the instruction object does not necessarily need to directly contact the operation surface of the touch panel display screen for touch sensors to detect the instruction object and perform processing described herein. For example, in an embodiment, the touch panel 1130 may detect a position of a user's finger around an edge of the display panel 1120 (e.g., gripping a protective case that surrounds the display/touch panel). Signals may be transmitted by the touch panel driver, e.g. in response to a detection of a touch operation, in response to a query from another element based on timed data exchange, etc.

The touch panel 1130 and the display 1120 may be surrounded by a protective casing, which may also enclose the other elements included in the user device 20. In an embodiment, a position of the user's fingers on the protective casing (but not directly on the surface of the display 1120) may be detected by the touch panel 1130 sensors. Accordingly, the controller 1110 may perform display control processing described herein based on the detected position of the user's fingers gripping the casing. For example, an element in an interface may be moved to a new location within the interface (e.g., closer to one or more of the fingers) based on the detected finger position.

Further, in an embodiment, the controller 1110 may be configured to detect which hand is holding the user device 20, based on the detected finger position. For example, the touch panel 1130 sensors may detect fingers on the left side of the user device 20 (e.g., on an edge of the display 1120 or on the protective casing), and detect a single finger on the right side of the user device 20. In this exemplary scenario, the controller 1110 may determine that the user is holding the user device 20 with his/her right hand because the detected grip pattern corresponds to an expected pattern when the user device 20 is held only with the right hand.

The operation key 1140 may include one or more buttons or similar external control elements, which may generate an operation signal based on a detected input by the user. In addition to outputs from the touch panel 1130, these operation signals may be supplied to the controller 1110 for performing related processing and control. In certain aspects of the present disclosure, the processing and/or functions associated with external buttons and the like may be performed by the controller 1110 in response to an input operation on the touch panel 1130 display screen rather than the external button, key, etc. In this way, external buttons on the user device 20 may be eliminated in lieu of performing inputs via touch operations, thereby improving watertightness.

The antenna 1106 may transmit/receive electromagnetic wave signals to/from other external apparatuses, and the short-distance wireless communication processor 1107 may control the wireless communication performed between the other external apparatuses. Bluetooth, IEEE 802.11, and near-field communication (NFC) are non-limiting examples of wireless communication protocols that may be used for inter-device communication via the short-distance wireless communication processor 1107.

The user device 20 may include a motion sensor 1108. The motion sensor 1108 may detect features of motion (i.e., one or more movements) of the user device 20. For example, the motion sensor 1108 may include an accelerometer to detect acceleration, a gyroscope to detect angular velocity, a geomagnetic sensor to detect direction, a geo-location sensor to detect location, etc., or a combination thereof to detect motion of the user device 20. In an embodiment, the motion sensor 1108 may generate a detection signal that includes data representing the detected motion. For example, the motion sensor 1108 may determine a number of distinct movements in a motion (e.g., from start of the series of movements to the stop, within a predetermined time interval, etc.), a number of physical shocks on the user device 20 (e.g., a jarring, hitting, etc., of the electronic device), a speed and/or acceleration of the motion (instantaneous and/or temporal), or other motion features. The detected motion features may be included in the generated detection signal. The detection signal may be transmitted, e.g., to the controller 1110, whereby further processing may be performed based on data included in the detection signal. The motion sensor 1108 can work in conjunction with a Global Positioning System (GPS) section 1160. The information of the present position detected by the GPS section 1160 is transmitted to the controller 1110. An antenna 1161 is connected to the GPS section 1160 for receiving and transmitting signals to and from a GPS satellite.

The user device 20 may include a camera section 1109, which includes a lens and shutter for capturing photographs of the surroundings around the user device 20. In an embodiment, the camera section 1109 captures surroundings of an opposite side of the user device 20 from the user. The images of the captured photographs can be displayed on the display panel 1120. A memory section saves the captured photographs. The memory section may reside within the camera section 109 or it may be part of the memory 1150. The camera section 1109 can be a separate feature attached to the user device 20 or it can be a built-in camera feature.

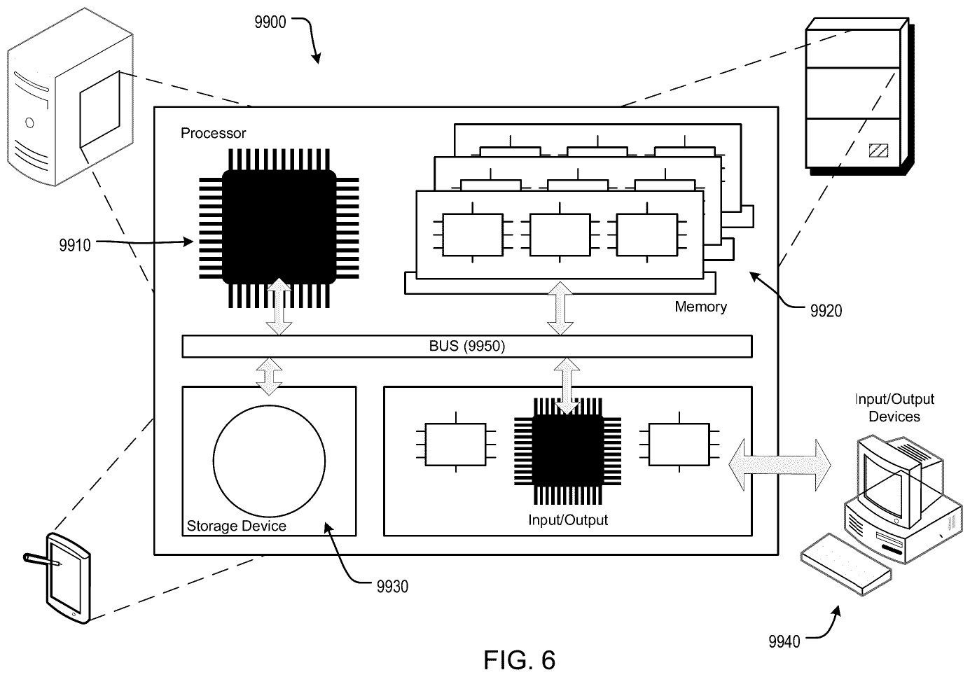

An example of a type of computer is shown in FIG. 6. The computer 9900 can be used for the operations described in association with any of the computer-implement methods described previously, according to one implementation. For example, the computer 9900 can be an example of devices 125, 195, or a server (such as the second electronic device 190). The computer 9900 includes processing circuitry, as discussed above. The second electronic device 190 can include other components not explicitly illustrated in FIG. 6 such as a CPU, GPU, frame buffer, etc. The processing circuitry includes one or more of the elements discussed next with reference to FIG. 6. In FIG. 6, the computer 9900 includes a processor 9910, a memory 9920, a storage device 9930, and an input/output device 9940. Each of the components 9910, 9920, 9930, and 9940 are interconnected using a system bus 9950. The processor 9910 is capable of processing instructions for execution within the system 9900. In one implementation, the processor 9910 is a single-threaded processor. In another implementation, the processor 9910 is a multi-threaded processor. The processor 9910 is capable of processing instructions stored in the memory 9920 or on the storage device 9930 to display graphical information for a user interface on the input/output device 9940.

The memory 9920 stores information within the computer 9900. In one implementation, the memory 9920 is a computer-readable medium. In one implementation, the memory 9920 is a volatile memory unit. In another implementation, the memory 9920 is a non-volatile memory unit.

The storage device 9930 is capable of providing mass storage for the computer 9900. In one implementation, the storage device 9930 is a computer-readable medium. In various different implementations, the storage device 9930 may be a floppy disk device, a hard disk device, an optical disk device, or a tape device.

The input/output device 9940 provides input/output operations for the computer 9900. In one implementation, the input/output device 9940 includes a keyboard and/or pointing device. In another implementation, the input/output device 9940 includes a display unit for displaying graphical user interfaces.

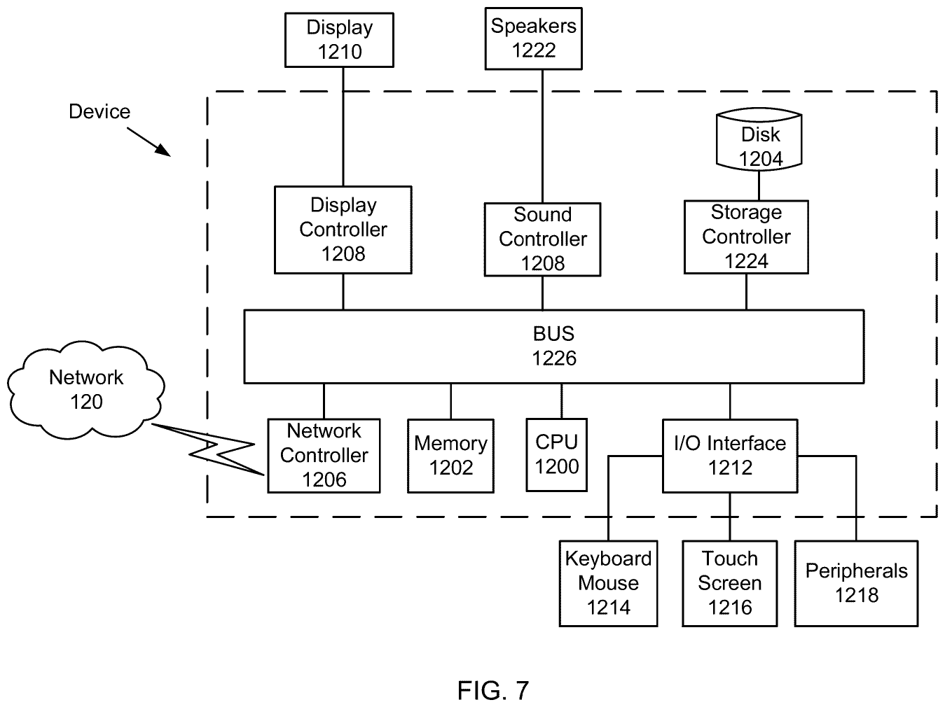

Next, a hardware description of a device according to exemplary embodiments is described with reference to FIG. 7. In FIG. 7, the device 1201, which can be the above-described devices of FIG. 1, includes processing circuitry, as discussed above. The processing circuitry includes one or more of the elements discussed next with reference to FIG. 7. The device can include other components not explicitly illustrated in FIG. 7, such as a CPU, GPU, frame buffer, etc. In FIG. 7, the device includes a CPU 1200 which performs the processes described above/below. The process data and instructions may be stored in memory 1202. These processes and instructions may also be stored on a storage medium disk 1204 such as a hard drive (HDD) or portable storage medium or may be stored remotely. Further, the claimed advancements are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the device 1201 communicates, such as a server or computer.

Further, the claimed advancements may be provided as a utility application, background daemon, or component of an operating system, or combination thereof, executing in conjunction with CPU 1200 and an operating system such as Microsoft Windows, UNIX, Solaris, LINUX, Apple MAC-OS and other systems known to those skilled in the art.

The hardware elements in order to achieve the device 1201 may be realized by various circuitry elements, known to those skilled in the art. For example, CPU 1200 may be a Xenon or Core processor from Intel of America or an Opteron processor from AMD of America, or may be other processor types that would be recognized by one of ordinary skill in the art. Alternatively, the CPU 1200 may be implemented on an FPGA, ASIC, PLD or using discrete logic circuits, as one of ordinary skill in the art would recognize. Further, CPU 1200 may be implemented as multiple processors cooperatively working in parallel to perform the instructions of the processes described above. CPU 1200 can be an example of the CPU illustrated in each of the devices of FIG. 1.

The device in FIG. 7 also includes a network controller 1206, such as an Intel Ethernet PRO network interface card from Intel Corporation of America, for interfacing with network 120 (also shown in FIG. 1), and to communicate with the other devices of FIG. 1. As can be appreciated, the network 120 can be a public network, such as the Internet, or a private network such as an LAN or WAN network, or any combination thereof and can also include PSTN or ISDN sub-networks. The network 120 can also be wired, such as an Ethernet network, or can be wireless such as a cellular network including EDGE, 3G, 4G and 5G wireless cellular systems. The wireless network can also be WiFi, Bluetooth, or any other wireless form of communication that is known.

The device further includes a display controller 1208, such as a NVIDIA Geforce GTX or Quadro graphics adaptor from NVIDIA Corporation of America for interfacing with display 1210, such as an LCD monitor. A general purpose I/O interface 1212 interfaces with a keyboard and/or mouse 1214 as well as a touch screen panel 1216 on or separate from display 1210. General purpose I/O interface also connects to a variety of peripherals 1218 including printers and scanners.

A sound controller 1220 is also provided in the device 1201 to interface with speakers/microphone 1222 thereby providing sounds and/or music.

The general-purpose storage controller 1224 connects the storage medium disk 1204 with communication bus 1226, which may be an ISA, EISA, VESA, PCI, or similar, for interconnecting all of the components of the device. A description of the general features and functionality of the display 1210, keyboard and/or mouse 1214, as well as the display controller 1208, storage controller 1224, network controller 1206, sound controller 1220, and general purpose I/O interface 1212 is omitted herein for brevity as these features are known.

While this specification contains many specific implementation details, these should not be construed as limitations on the scope of what may be claimed, but rather as descriptions of features that may be specific to particular embodiments.

Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

Thus, the foregoing discussion discloses and describes merely exemplary embodiments of the present disclosure. As will be understood by those skilled in the art, the present disclosure may be embodied in other specific forms without departing from the spirit thereof. Accordingly, the disclosure of the present disclosure is intended to be illustrative, but not limiting of the scope of the disclosure, as well as other claims. The disclosure, including any readily discernible variants of the teachings herein, defines, in part, the scope of the foregoing claim terminology such that no inventive subject matter is dedicated to the public.

1. A dynamic alarm system, comprising:
an integrated sensor system, including
a computing device including a processor, a memory, and a communication module, and
an internet of things (IoT) sensor communicatively connected to the computing device, the IoT sensor configured to obtain traffic data;
a first electronic device communicatively connected to the computing device and configured to generate an audio, visual, or physical alert; and
a cloud system communicatively connected to the computing device via the communication module and the first electronic device, the cloud system configured to analyze the obtained traffic data based on an artificial intelligence model,
wherein the cloud system includes processing circuitry configured to
receive an input including a starting location, a destination, and a time of arrival from a user,
receive the traffic data from the integrated sensor system,
generate a first route option and corresponding first route data,
determine, based on the first route option and corresponding first route data, a total time to the destination,
determine a dynamic alarm set time based on the total time to destination and the time of arrival, and
instruct the first electronic device to set a dynamic alarm based on the alarm set time.

2. The system of claim 1, wherein
the cloud system is configured to train the artificial intelligence model with the traffic data and external factor data, and
the artificial intelligence model is configured to generate one or more routes from the starting location to the destination, compute an estimated travel time of each route of the one or more routes, determine an optimal route from the one or more routes based on a ranking of the estimated travel time, and generate analyzed data including the optimal route.

3. The system of claim 2, wherein
the IoT sensor is installed on, in, or under a road proximate to the one or more routes,
the IoT sensor includes a plurality of sensor tracks, each sensor track in the form of a loop of flat sensor wire having a height that is 0.1 to 0.3 times the width of the sensor track, the loop installed such that the width of the sensor track is orthogonal to an uppermost surface of a road on the route,
the sensor tracks are disposed at a first distance no closer than 0.5×the largest diameter of the loop, and
each loop is electrically connected to a feeder line that is orthogonal to a line of propagation of the sensor tracks in the direction of traffic.

4. The system of claim 3, wherein the integrated sensor system includes a plurality of the IoT sensors connected in series and spaced by a predetermined distance.

5. The system of claim 4, wherein
the plurality of IoT sensors includes a first piezoelectric sensor and a second piezoelectric sensor, and
the first piezoelectric sensor and the second piezoelectric sensor are configured to detect a voltage change in pairs in response to a vehicle travelling on the road to count a number of vehicles per a predetermined time interval.

6. The system of claim 5, wherein the cloud system is configured to receive the traffic data from the computing device and generate traffic metrics based on the number of vehicles per the predetermined time interval and determine, based on the traffic metrics, the total time to the destination.

7. The system of claim 1, wherein the input further includes a plurality of user-defined events and a preparation time.

8. The system of claim 7, wherein the cloud system is further configured to
modify the total time to the destination based on the preparation time, and
determine the dynamic alarm set time based on the traffic metrics and the total time to the destination.

9. The system of claim 1, wherein the cloud system is further configured to
receive external factor data,
generate the first route option based on the traffic data and the external factor data, and
determine the total time to the destination based on the first route option and the external factor data.

10. The system of claim 1, wherein the cloud system is further configured to
receive updated traffic data,
generate an updated route option and corresponding updated route data based on the updated traffic data,
determine an updated total time to destination and an updated dynamic alarm set time, and
transmit instructions to the first electronic device to modify the set dynamic alarm to the updated dynamic alarm set time.

11. A method of setting a dynamic alarm, comprising:
receiving an input including a starting location, a destination, a time of arrival, a plurality of user-defined events, and a preparation time from a user;
receiving traffic data from an integrated sensor system including a computing device including a processor, a memory, and a communication module, and an internet of things (IoT) sensor communicatively connected to the computing device, the IoT sensor configured to obtain traffic data;
generating a first route option from the starting location to the destination based on the traffic data and the input from the user;
determining, via an artificial intelligence model and based on the first route option, a total time to the destination;
determining a dynamic alarm set time based on the total time to destination and the time of arrival; and
instructing a first electronic device to set a dynamic alarm based on the alarm set time.

12. The method of claim 11, further comprising
training the artificial intelligence model with the traffic data from the integrated sensor system, the time of arrival, the preparation time, and external factor data;
determining an estimated travel time of one or more routes with the trained artificial intelligence model;
determining, based on the determined estimated travel times, an optimal route from the one or more routes based on a ranking of the estimated travel time; and
determining the dynamic alarm set time based on the estimated travel time of the optimal route.

13. The method of claim 12, wherein
the IoT sensor is installed on, in, or under a road proximate to the one or more routes,
the IoT sensor includes a plurality of sensor tracks, each sensor track in the form of a loop of flat sensor wire having a height that is 0.1 to 0.3 times the width of the sensor track, the loop installed such that the width of the sensor track is orthogonal to an uppermost surface of a road on the route,
the sensor tracks are disposed at a first distance no closer than 0.5×the largest diameter of the loop, and
each loop is electrically connected to a feeder line that is orthogonal to a line of propagation of the sensor tracks in the direction of traffic.

14. The method of claim 13, wherein the integrated sensor system includes a plurality of IoT sensors connected in series and spaced by a predetermined distance.

15. The method of claim 14, wherein
the plurality of IoT sensors includes a first piezoelectric sensor and a second piezoelectric sensor, and
the first piezoelectric sensor and the second piezoelectric sensor are configured to detect a voltage change in pairs in response to a vehicle travelling on the road to count a number of vehicles per a predetermined time interval.

16. The method of claim 15, wherein the cloud system is configured to receive the traffic data from the computing device and generate traffic metrics based on the number of vehicles per the predetermined time interval and determine, based on the traffic metrics, the total time to the destination.

17. The method of claim 16, wherein the input further includes a plurality of user-defined events and a preparation time.

18. The method of claim 17, further comprising
modifying the total time to the destination based on the preparation time; and
determining the dynamic alarm set time based on the traffic metrics and the total time to the destination.

19. The method of claim 11, further comprising
receiving external factor data;
generating the first route option based on the traffic data and the external factor data; and
determining the total time to the destination based on the first route option and the external factor data.

20. The method of claim 11, further comprising
receiving updated traffic data;
generating an updated route option and corresponding updated route data based on the updated traffic data;
determining an updated total time to destination and an updated dynamic alarm set time; and
transmitting instructions to the first electronic device to modify the set dynamic alarm to the updated dynamic alarm set time.
